(19) United States
(12) Patent Application Publication
(10) Pub. No.: US 2005/0246418 A1
(43) Pub. Date: Nov. 3, 2005

(54) Server and display device

(75) Inventors: Youko Tanaka, Mizuho-city (JP); Yoshinori Hatayama, Komaki City (JP); Hiroshi Takemura, Ama-Gun (JP); Hayato Ikebe, Anpachi-gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/100,422

(22) Filed: Apr. 7, 2005

(30) Foreign Application Priority Data
Apr. 28, 2004 (JP) 2004-133373 (P)

(51) Int. Cl. G06F 15/16

(52) U.S. Cl. 709/203

(57) ABSTRACT

A server installed indoors determines whether or not an abnormality has occurred indoors. If the server determines that the abnormality has occurred, it causes an indoor display device having a display function to display a visually effective warning. A user is thereby promptly informed of the occurrence of the abnormality, and an appropriate countermeasure is swiftly taken. Upon detecting an indoor abnormality, the server decides on a display device for displaying the abnormality on the basis of a condition of a display device for displaying an abnormality and the circumstances of display devices connected to a network. Further, the server forms a screen used to report the abnormality depending on the contents thereof, and causes the display device, which has been decided on for the display of the abnormality, to display the screen.

### BACKGROUND OF THE INVENTION

1. Field of the Invention

The present invention relates to a server and a display device connected thereto, and more particularly to a server and a display device that are suitably used in reporting to a user an abnormality occurring in a local area such as an indoor space.

2. Description of the Related Art

As a method of reporting to a user an intrusion of a suspicious individual upon detection thereof, it has been proposed to display the fact of the intrusion in a dedicated terminal, to issue a warning sound, and so forth.

JP 2002-251684 A discloses a system that detects viewers' behaviors and room situations on the basis of an inputting situation resulting from a user's operation of a remote controller or an operation panel or information obtained from a sensor attached to a television system, and that makes an abnormality determination on the basis of a result of the detection and stored data. In this system, when it is determined that an abnormality has occurred, a center server installed in a viewer center is advised of the abnormality. Furthermore, the center server provides a display of inquiry to a bidirectional television at a sending end.

In the aforementioned system, when an abnormality occurs indoors, an outdoor center server is advised of the occurrence of the abnormality. Upon confirmation of the abnormality in the center server, an instruction is issued to the user via a network. If the user is absent at this moment, a fire department or a police station is advised of the abnormality. The number of false reports to the fire department or the police station is considered to be reduced by adopting the processing procedure mentioned above. However, the fact that it is necessary to establish communication with the outdoor center server causes a problem in that it takes a long time before the fire department or the police station is advised of the abnormality.

Moreover, if an illegal intruder responds to the aforementioned system passing himself or herself off as a resident, the center server may not be able to detect the abnormality. Also, because the user (resident) is advised using letters or a speech sound, he or she may slip over the advice.

Further, in the aforementioned system, since an abnormality is reported by means of the dedicated terminal, the user may not notice the occurrence of the abnormality when he or she is not near the terminal. The number of dedicated terminals may be increased to avoid such an incident, in which case, however, a cost increase is incurred.

### SUMMARY OF THE INVENTION

It is an object of the present invention, which has been made in terms of the above-mentioned circumstances, to promptly and accurately advise a user of an abnormality that has occurred in a local area such as an indoor space.

In the present invention, a server installed in a local area makes a determination on an abnormality in the local area. This eliminates the necessity to establish communication with a center server provided outside or the like, and makes it possible to promptly detect the occurrence of the abnormality and promptly report the abnormality to the user. Further, in the present invention, a display device having a display function such as a television, which is installed beforehand in the local area, displays a visually effective warning. Thus, the user can be accurately advised of the contents of the abnormality. Also, because no dedicated terminal is used as display means, a rise in cost resulting from a possible increase in the number of dedicated terminals can be avoided. Still further, in the present invention, a display device that is quite likely to be looked at by the user, such as a display device that is on or a display device located in proximity to someone, is selected as a display device for displaying a warning. Thus, the user can be more reliably advised of the occurrence of the abnormality.

According to a first aspect of the present invention, there is provided a server connected to a display device in a home network, the server including: an abnormality occurrence determining portion that determines that an abnormality has occurred; and a display device determining portion that decides on a display device for reporting an abnormality based on a condition for selecting an abnormality reporting display device and information on display devices in the home network, when the abnormality occurrence determining portion determines that the abnormality has occurred.

The server according to the first aspect may further include a mail sending portion that sends to a predetermined address a mail including information indicating that an abnormality has occurred, when the display device determining portion decides that there is no abnormality reporting display device.

The server according to the first aspect may further include a control information sending portion that sends control information as an instruction for reporting to the display device on which the display device determining portion has decided.

Further, in the server according to the first aspect, the abnormality occurrence determining portion may include an abnormality analyzing portion that analyzes contents of an occurrent abnormality, and the control information sending portion may send control information as an instruction for reporting to the display device on which the display device determining portion has decided, based on a result of an abnormality analysis conducted by the abnormality analyzing portion.

Herein, the control information is information that designates a reporting image to be displayed.

The server according to the first aspect may further include: an image generating portion that generates a reporting image; and an image sending portion that sends the generated image to the display device on which the display device determining portion has decided. Herein, the control information sending portion may control, based on a result of an abnormality analysis conducted by the abnormality analyzing portion, the image generating portion to generate a reporting image, and control the image sending portion to send the generated image therefrom.

Further, in the server according to the first aspect, the control information sending portion may send to a camera connected to the home network control information as an instruction to send a picked-up image to the display device on which the display device determining portion has decided, based on a result of an abnormality analysis conducted by the abnormality analyzing portion, and send to the display device on which the display device determining portion has decided control information as an instruction to display an image received from the camera.

Further, in the server according to the first aspect, the condition for selecting the abnormality reporting display device includes that a power source of the display device is on. Further, the condition for selecting the abnormality reporting display device includes that there is someone in proximity to the display device. Alternatively, the condition for selecting the abnormality reporting display device includes that all the display devices connected to the home network report the abnormality.

Further, in the server according to the first aspect, the display device may be a television and may further include: a display device use situation determining portion that determines whether or not the display device on which the display device determining portion has decided is currently displaying a television program; and a recording instructing portion that provides a recorder connected to the home network with an instruction to record a program of a channel currently selected by the display device, including information indicating the channel, if the display device use situation determining portion determines that the display device on which the display device determining portion has decided is currently displaying the television program.

According to a second aspect of the present invention, there is provided a display device connected to a server for controlling an equipment in a home network, the display device including: an image storing portion that stores an image used to report an abnormality; a control information processing portion that receives control information as an instruction to report an abnormality from the server and controls the reporting of the abnormality based on the received control information; and a display portion that displays the image stored in the image storing portion based on the control performed by the control information processing portion.

In the display device according to the second aspect, the display portion may synthesize information different from the image stored in the image storing portion with the image based on the control performed by the control information processing portion, and may display a resultant synthetic image.

The display device according to the second aspect may further include a camera image receiving portion that receives an image from a camera in the network, in which the display portion may synthesize a camera image received from the camera image receiving portion with the image stored in the image storing portion based on the control performed by the control information processing portion, and display a resultant synthetic image.

According to the foregoing first and second aspects, when an abnormality occurs, the indoor server makes a determination on the abnormality. This makes it possible to reduce the time required for communication with the outside and to prevent the growth of danger through a quicker response. Further, the use of an image as well as letters for a warning to be issued makes it easy for the user to recognize the warning.

Moreover, the issuance of a warning to the indoor display device endowed with the display function, including a television or the like in a room, makes it possible to provide an environment allowing the user staying indoors to notice the warning easily.

### BRIEF DESCRIPTION OF THE DRAWINGS

The foregoing and other objects and novel features of the present invention will become more perfectly understandable by reading the following description of its embodiments in conjunction with the following accompanying drawings, wherein:

FIG. 1 shows a configuration of a warning system according to a first embodiment of the present invention;

FIG. 2 shows a configuration of a home server according to the first embodiment of the present invention;

FIG. 3 shows a configuration of a terminal according to the first embodiment of the present invention;

FIG. 4 shows a configuration of a television according to the first embodiment of the present invention;

FIG. 5 shows a structure of equipment information according to the first embodiment of the present invention;

FIG. 6A shows a structural example of condition information for selecting the television according to the first embodiment of the present invention;

FIG. 6B shows a structural example of condition information for setting a display area according to the first embodiment of the present invention;

FIG. 7A shows a structural example of a reporting screen according to the first embodiment of the present invention;

FIG. 7B shows a structural example of a reporting screen according to the first embodiment of the present invention;

FIG. 7C shows a structural example of a reporting screen according to the first embodiment of the present invention;

FIG. 7D shows a structural example of a reporting screen according to the first embodiment of the present invention;

FIG. 8 is a flowchart showing a basic flow of an abnormality reporting processing according to the first embodiment of the present invention;

FIG. 9 is a flowchart showing a processing performed upon the occurrence of an abnormality according to the first embodiment of the present invention;

FIG. 10 is a flowchart showing an equipment information setting processing according to the first embodiment of the present invention;

FIG. 11 is a flowchart showing a selection condition setting processing according to the first embodiment of the present invention;

FIG. 12 shows a configuration of a warning system according to a second embodiment of the present invention;

FIG. 13 is a flowchart showing a basic flow of an abnormality reporting processing according to the second embodiment of the present invention.

### DETAILED DESCRIPTION OF THE PREFERRED EMBODIMENTS

The embodiments of the present invention will be described hereinafter with reference to the drawings. In the embodiments, the present invention is applied to a network system constructed indoors.

(First Embodiment)

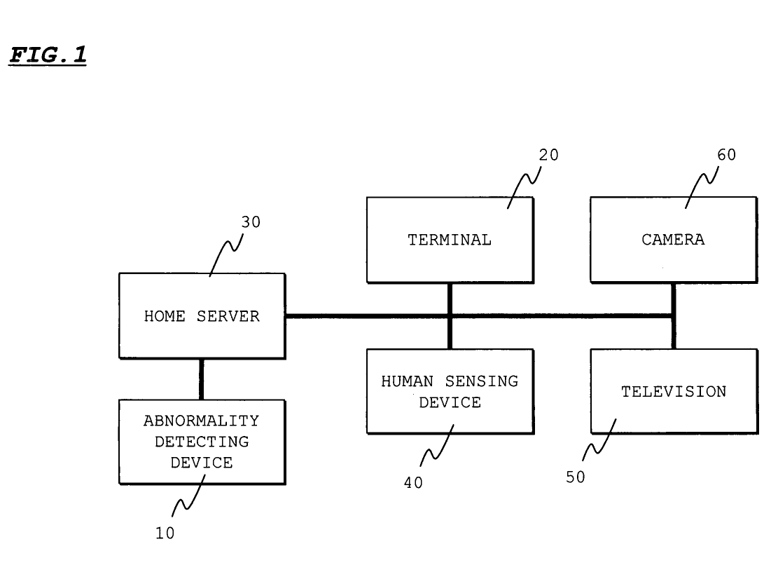

FIG. 1 shows a configurational example of a warning system according to a first embodiment of the present invention.

The warning system is composed of an abnormality detecting device 10, a terminal 20, a home server 30, a human sensing device 40, a television 50, and a camera 60. The abnormality detecting device 10, the terminal 20, the human sensing device 40, the television 50, and the camera 60 are connected to the home server 30 via a network.

Both the abnormality detecting device 10 and the human sensing device 40 are constructed as human sensors, vibration sensors, or the like. These sensors detect an approach of a person, vibrations of a window, or the like (hereinafter referred to as “a detection target event”). Upon detecting such a detection target event, the sensors send to the home server 30 event occurrence information indicating that the detection target event has occurred. In a room equipped with the television 50, at least one human sensing device 40 is always installed. In this embodiment, the human sensing device 40 can detect whether or not there is a person in proximity to the television 50.

The terminal 20 controls a user's input concerning the equipments connected to the network. The terminal 20 also displays various pieces of information such as information indicating states of the equipments and information on a warning.

The home server 30 controls the equipments connected via the network. Especially upon receiving event occurrence information from the abnormality detecting device 10 connected to the network, the home server 30 determines whether or not the received information indicates the occurrence of an abnormality. After having determined that the abnormality has occurred, the home server 30 controls the television 50 placed indoors to cause it to output the occurrence of the abnormality.

The television 50 receives existing television broadcasts and outputs the occurrence of an abnormality on the basis of control information obtained from the home server 30.

The camera 60 outputs to the television 50 and the home server 30 image information acquired by an image pickup portion on the basis of control information sent from the home server 30.

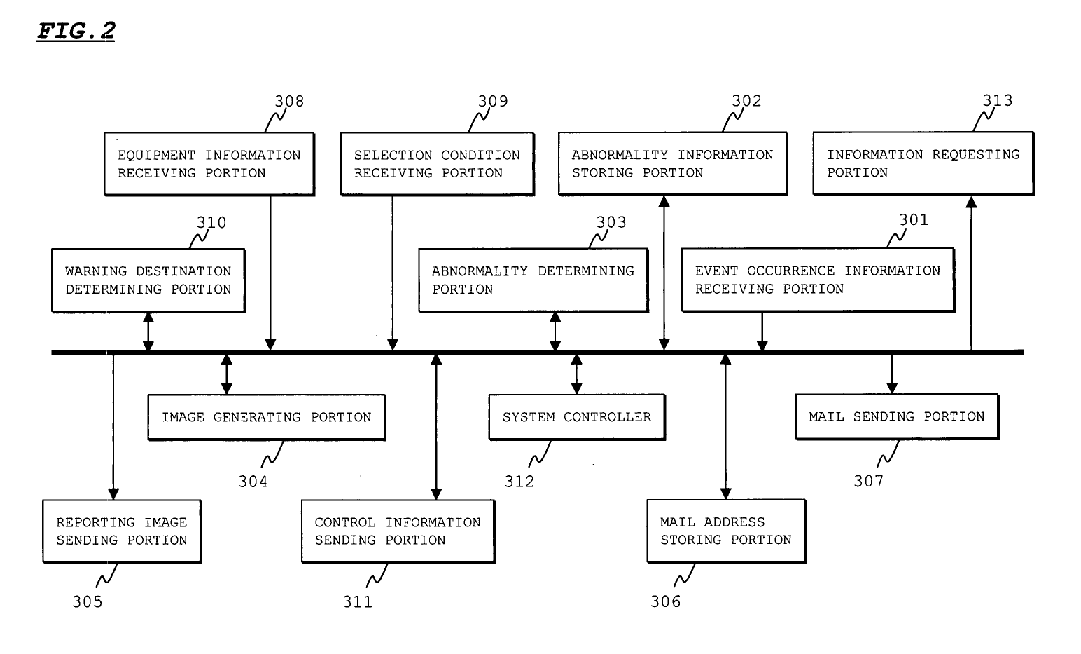

FIG. 2 is a functional block diagram of the home server 30.

Referring to FIG. 2, the configuration of the home server 30 will be described. As shown in FIG. 2, the home server 30 includes an event occurrence information receiving portion 301, an abnormality information storing portion 302, an abnormality determining portion 303, an image generating portion 304, a reporting image sending portion 305, a mail address storing portion 306, a mail sending portion 307, an equipment information receiving portion 308, a selection condition receiving portion 309, a warning destination determining portion 310, a control information sending portion 311, a system controller 312, and an information requesting portion 313.

The event occurrence information receiving portion 301 receives event occurrence information sent from the abnormality detecting device 10.

The abnormality information storing portion 302 stores in an interrelated manner event occurrence information received so far by the event occurrence information receiving portion 301, information indicating whether or not the event occurrence information indicates an abnormal state, and a result of a determination made by the abnormality determining portion 303 as to the contents of an abnormality. The abnormality determining portion 303 refers to the information stored in the abnormality information storing portion 302.

Using the information stored in the abnormality information storing portion 302, the abnormality determining portion 303 determines whether or not the event occurrence information received by the event occurrence information receiving portion 301 indicates an abnormal state. If the event occurrence information indicates the abnormal state, the abnormality determining portion 303 analyzes and identifies the abnormal state, and sends to the control information sending portion 311 control information for reporting the occurrence of an abnormality, which includes a result of the analysis.

The image generating portion 304 generates image information for informing the user of the occurrence of an abnormality. The reporting image sending portion 305 sends to the television 50 the image information generated by the image generating portion 304.

The mail address storing portion 306 stores a mail address of a person to which a warning is issued. The mail sending portion 307 sends to a destination address a mail for announcing the occurrence of an abnormality.

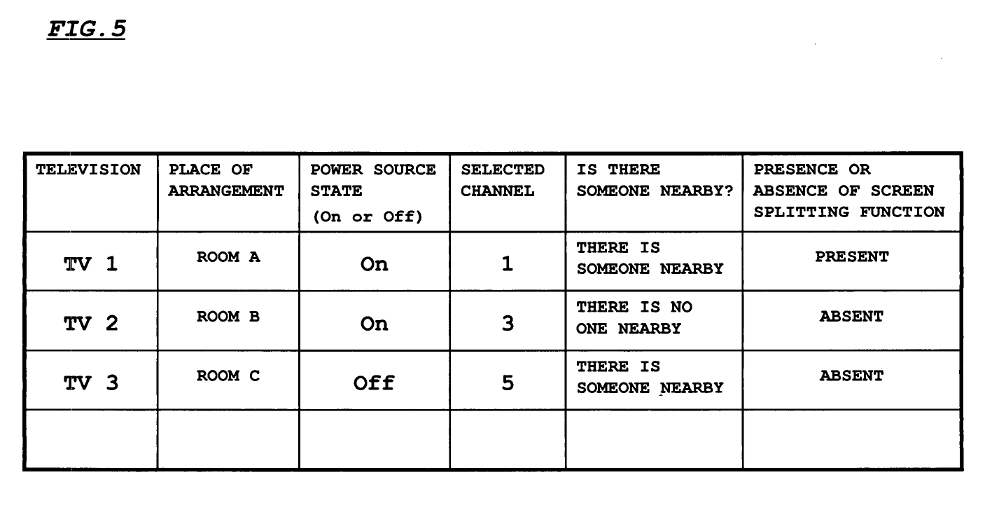

The equipment information receiving portion 308 receives equipment information sent by the terminal 20. This equipment information includes the states, functions, and the like of the equipments connected to the network. Details of the equipment information on the television 50 (hereinafter referred to as “TV equipment information”) will be described later with reference to FIG. 5.

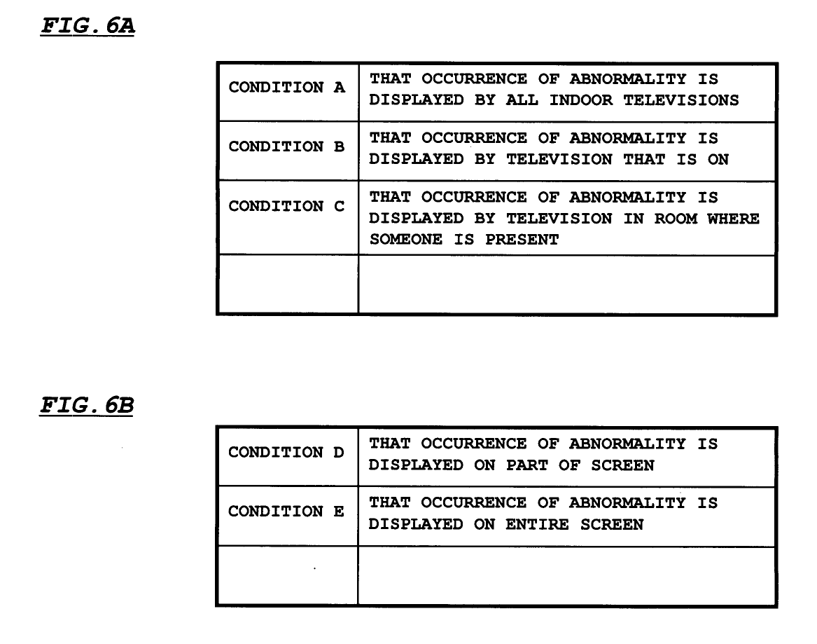

The selection condition receiving portion 309 receives from the terminal 20 information on a condition for selecting a television caused to output the occurrence of an abnormality (hereinafter referred to as “TV selection condition information”) and information on a condition of an area for displaying an abnormality warning image in a television display area (hereinafter referred to as “TV display condition information”). Details of these pieces of information will be described later with reference to FIGS. 6A and 6B.

The warning destination determining portion 310 decides on a television caused to output the occurrence of an abnormality on the basis of the TV equipment information received by the equipment information receiving portion 308 and the TV selection condition information received by the selection condition receiving portion 309.

In causing the television 50 to output the occurrence of an abnormality, the control information sending portion 311 sends to the corresponding television 50 and the corresponding camera 60 control information for causing the television to display a screen for displaying the occurrence of an abnormality, control information for incorporating an image picked up by the camera 60 into an output screen of the television 50, and the like, on the basis of control information received from the abnormality determining portion 303.

The system controller 312 controls the respective components in the home server 30. The information requesting portion 313 requests the terminal 20 to provide equipment information and information on a condition of a television used to output the occurrence of an abnormality.

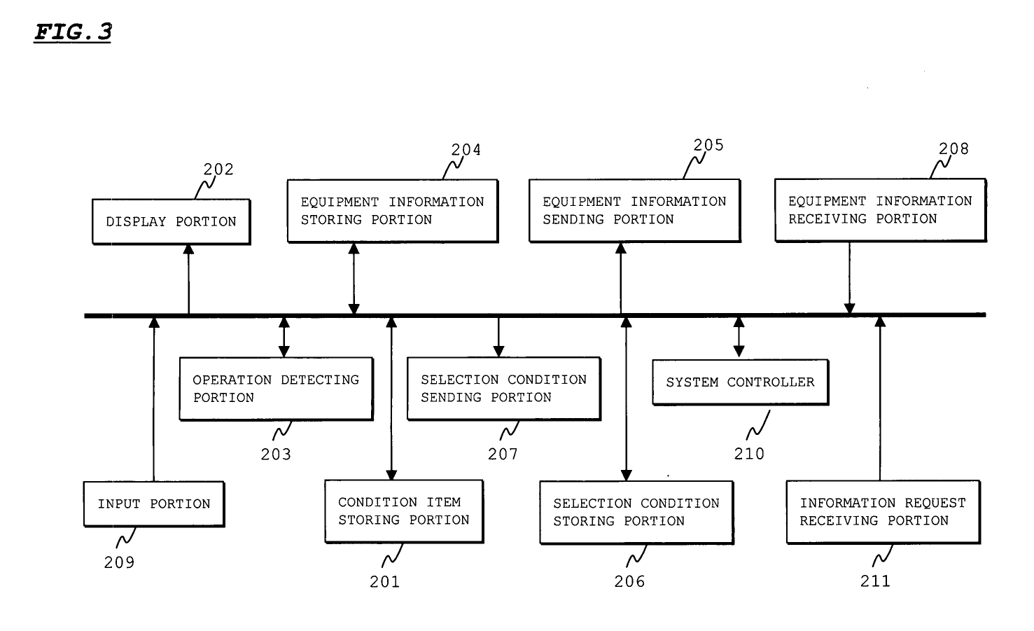

FIG. 3 is a functional block diagram of the terminal 20.

As shown in FIG. 3, the terminal 20 includes a condition item storing portion 201, a display portion 202, an operation detecting portion 203, an equipment information storing portion 204, an equipment information sending portion 205, a selection condition storing portion 206, a selection condition sending portion 207, an equipment information receiving portion 208, an input portion 209, a system controller 210, and an information request receiving portion 211.

The condition item storing portion 201 stores information on candidate conditions of a television for outputting the occurrence of an abnormality and candidate conditions of a display area for an abnormality warning image. As examples of the former candidate conditions, a condition “that the occurrence of the abnormality is displayed by all the indoor televisions”, a condition “that the occurrence of the abnormality is displayed by a television that is on”, a condition “that the occurrence of the abnormality is displayed by a television placed in a room where someone is present”, and the like are stored in the condition item storing portion 201. As examples of the latter candidate conditions, a condition “that the occurrence of the abnormality is displayed on part of the screen”, a condition “that the occurrence of the abnormality is displayed on the entire screen”, and the like are stored in the condition item storing portion 201.

The display portion 202 displays various pieces of information. The operation detecting portion 203 detects an operation input of the user to the input portion 209.

The equipment information storing portion 204 stores equipment information received by the equipment information receiving portion 208. This equipment information concerns the respective equipments connected to the network. The equipment information sending portion 205 sends to the home server 30 the equipment information stored in the equipment information storing portion 204.

The selection condition storing portion 206 stores conditions selected by the user (TV selection condition information and TV display condition information) out of the candidate conditions stored in the condition item storing portion 201. The selection condition sending portion 207 sends to the home server 30 the condition information stored in the selection condition storing portion 206.

The equipment information receiving portion 208 receives the equipment information sent from the equipments connected to the network. The input portion 209 controls an input from the user. The system controller 210 controls the respective components in the terminal 20.

The information request receiving portion 211 receives from the home server 30 requests to send equipment information, TV selection condition information, and TV display condition information. In response to the reception of the requests, the information request receiving portion 211 instructs the equipment information sending portion 205 to send the equipment information, and instructs the selection condition sending portion 207 to send the TV selection condition information and the TV display condition information.

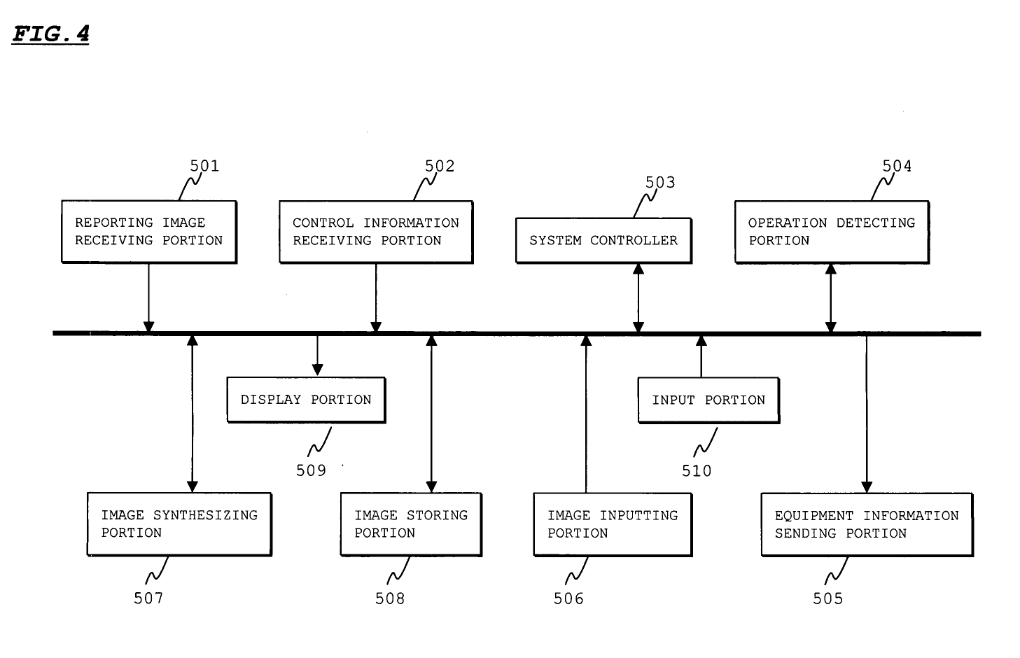

FIG. 4 is a functional block diagram of the television 50. In FIG. 4, while parts realizing the same functions as in the conventional television are omitted, configurational parts relating to the present invention are illustrated.

As shown in FIG. 4, the television 50 includes a reporting image receiving portion 501, a control information receiving portion 502, a system controller 503, an operation detecting portion 504, an equipment information sending portion 505, an image inputting portion 506, an image synthesizing portion 507, an image storing portion 508, a display portion 509, and an input portion 510.

The reporting image receiving portion 501 receives image information indicating the occurrence of an abnormality which has been sent from the home server 30.

The control information receiving portion 502 receives control information sent from the home server 30 as to the outputting of the occurrence of an abnormality. This control information designates a method of forming a screen used to display the occurrence of an abnormality, a method of displaying it, and the like. The control information receiving portion 502 performs a control for causing the display portion 509 to display a screen on the basis of the control information.

The system controller 503 controls the respective components in the television 50. The operation detecting portion 504 detects a user's inputting operation.

The equipment information sending portion 505 sends information on the television 50 to the terminal 20. This information includes information on operating states and information indicating whether or not the television 50 is endowed with a split-screen display function.

The image inputting portion 506 receives via the network image information acquired by being picked up by the camera 60. The image synthesizing portion 507 synthesizes images, texts, camera images, and the like according to an instruction (control information) from the home server 30, and generates an image for displaying the occurrence of an abnormality. The image storing portion 508 stores image information used to display the occurrence of an abnormality. The image information stored in the image storing portion 508 is readout according to an instruction (control information) from the home server 30, and is displayed by the display portion 509.

The display portion 509 displays an image for displaying the occurrence of an abnormality. The input portion 510 is an interface for turning power on and off, adjusting the volume, selecting a program, and so forth.

FIG. 5 shows a structural example of part of the TV equipment information.

As shown in FIG. 5, the TV equipment information includes information for identifying a television, information indicating a position of arrangement of a television, information on an on/off state of a power source, information on a selected channel, information indicating whether or not there is someone nearby, and information indicating the presence or absence of the split-screen display function. These pieces of information, which are associated with each television, are stored in the equipment information storing portion 204.

Out of these pieces of information, the information indicating the presence or absence of the split-screen display function is provided from the television 50 to the terminal 20 at the time of connection to the network, and is stored in the equipment information storing portion 204. The pieces of information on the states of the television 50 (the information on the on/off state of the power source and the information on the selected channel) are provided, as needed, from the television 50 to the terminal 20 after connection to the network, and are stored in an updating manner into the equipment information storing portion 204.

The information (equipment name) for identifying a television and the information indicating a location of arrangement or the like are set by the user's inputting operation from the terminal 20 at the time of connection to the network. These pieces of information are used in order for the user or other equipments to identify a newly connected equipment.

The information indicating whether or not there is someone nearby is provided, as appropriate, from the human sensing device 40 in a room equipped with the television 50 to the terminal 20, and is stored in an updating manner into the equipment information storing portion 204.

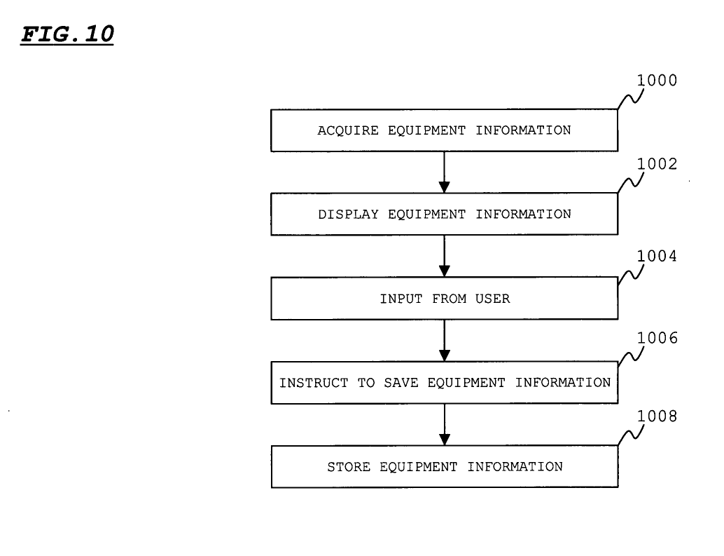

FIG. 10 is a flowchart schematically showing a processing performed in setting the aforementioned equipment information. A flow of the processing in connecting the television 50 to the indoor network will be described hereinafter with reference to FIG. 10.

First of all, when the television 50 is newly connected to the indoor network, the equipment information receiving portion 208 of the terminal 20 receives, through a plug-and-play function, information on the television 50 (including the information indicating the presence or absence of the split-screen display function) which is sent from the equipment information sending portion 505 of the television 50, and stores the received information into the equipment information storing portion 204 (S1000). The display portion 202 displays the stored information (S1002). If there is a change or the like in this information, the user inputs the changed information from the input portion 209. Furthermore, the user inputs information indicating a place where the television 50 is installed and information (equipment name) for identifying an equipment (S1004). After all the pieces of information on the equipment have been inputted and the user has issued an instruction to store all those pieces of information (S1006), the system controller 210 stores the inputted pieces of information into the equipment information storing portion 204 (S1008). The processing performed in connecting the television is thereby terminated.

After that, the terminal 20 continuously monitors an on/off state of the power source, a currently selected channel, and the like as to the television 50 connected to the network. If necessary, the home server 30 requests the terminal 20, through the information requesting portion 313, to send equipment information (TV equipment information) on the television 50, and acquires the equipment information on the television 50 from the terminal 20.

When the state of the television 50 changes due to an operational instruction from the home server 30, an operation of a remote controller by the user, or the like, the television 50 sends information indicating the change in its state from the equipment information sending portion 505 to the terminal 20.

After the equipment information receiving portion 208 has received information sent from the television 50, the terminal 20 stores the received information into the equipment information storing portion 204 through a control performed by the system controller 210. After having received from the home server 30 a request to send TV equipment information, the terminal 20 sends the TV equipment information stored in the equipment information storing portion 204 from the equipment information sending portion 205 to the home server 30.

FIGS. 6A and 6B exemplify conditions of a television for outputting the occurrence of an abnormality (TV selection condition information) and conditions of a display area for displaying the occurrence of an abnormality (TV display condition information), respectively.

FIG. 6A exemplifies the TV selection condition information. As described above, this condition information is stored in the condition item storing portion 201 of the terminal 20. The user selects a desired condition out of the candidate conditions contained in the condition information, and then sets the selected condition. In other words, in the case of FIG. 6A, the user selects a desired condition out of the candidate conditions “that the occurrence of an abnormality is displayed by all the indoor televisions”, “that the occurrence of an abnormality is displayed by a television that is on”, and “that the occurrence of an abnormality is displayed by a television placed in a room where someone is present”, and then sets the selected condition in the terminal 20. The set condition is stored into the selection condition storing portion 206 of the terminal 20.

FIG. 6B exemplifies the TV display condition information. As described above, these conditions are also stored in the condition item storing portion 201 of the terminal 20. The user selects a desired condition out of those conditions, and sets the selected condition. In other words, in the case of FIG. 6B, the user selects a desired condition out of the candidate conditions “that the occurrence of an abnormality is displayed on part of the screen” and “that the occurrence of an abnormality is displayed on the entire screen”, and then sets the selected condition in the terminal 20. The set condition is stored into the selection condition storing portion 206 of the terminal 20.

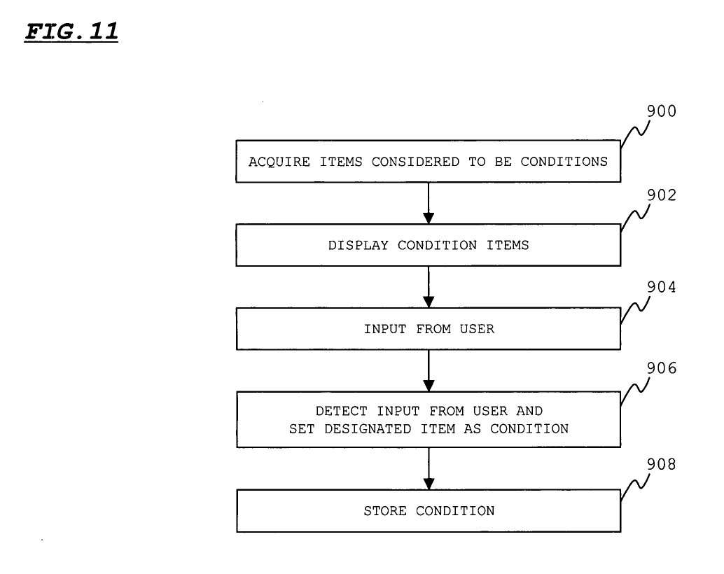

FIG. 11 is a flowchart schematically showing a processing performed in selecting a condition.

First of all, the terminal 20 acquires the candidate conditions stored in advance in the condition item storing portion 201 (S900), and causes the display portion 202 to display the acquired candidate conditions (S902). Then, according to the user's input from the input portion 210, a condition desired by the user is selected out of the displayed candidate conditions (S904). When the operation detecting portion 203 detects a selection input by the user (S906), the system controller 210 stores the selected condition into the selection condition storing portion 206 as a selection condition (S908). The processing of selecting and setting the condition is thereby terminated.

These processing are performed respectively in selecting and setting the condition of the television for outputting the occurrence of an abnormality (FIG. 6A) and in selecting and setting the condition of the display area for displaying the occurrence of an abnormality (FIG. 6B).

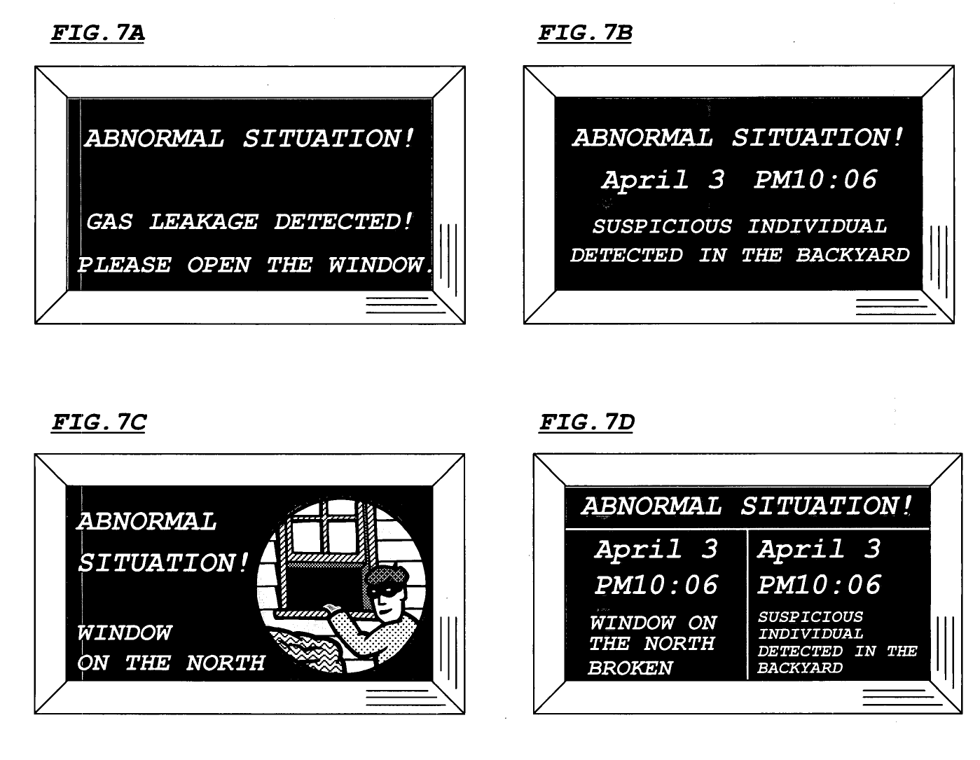

FIGS. 7A to 7D show image examples displayed by the television 50 at the time of the occurrence of an abnormality.

FIG. 7A shows an image example that is displayed in the case where a place of the occurrence of an abnormality or a countermeasure against an abnormality can be specified, for example, in the case where an abnormal state such as gas leakage is detected. Standard image information is stored in advance in the image storing portion 508 of the television 50. Out of the images contained in the image information, images corresponding to the place of the occurrence and the countermeasure are read out and displayed. In this case, nothing is required but to readout the standard image information, and there is no need to process the images. Therefore, the images can be promptly displayed.

FIG. 7B shows a display image in the case where information indicating a place of the occurrence of an abnormality is synthesized with a “suspicious individual detecting” image stored in advance in the image storing portion 508 of the television 50 and then is outputted, for example, when a suspicious individual is detected.

FIG. 7C shows a display image in the case where an image picked up by the camera 60 is synthesized with an abnormality occurrence reporting image stored in advance in the image storing portion 508 of the television 50 and then is outputted.

FIG. 7D shows a display image that is outputted, for example, in the case where many pieces of information are simultaneously reported or where the simultaneous occurrence of a plurality of abnormal situations is reported. The image information in the case where many pieces of information are synthesized as in this case is generated by the home server 30.

Next, an operation example of the warning system of the present invention will be described.

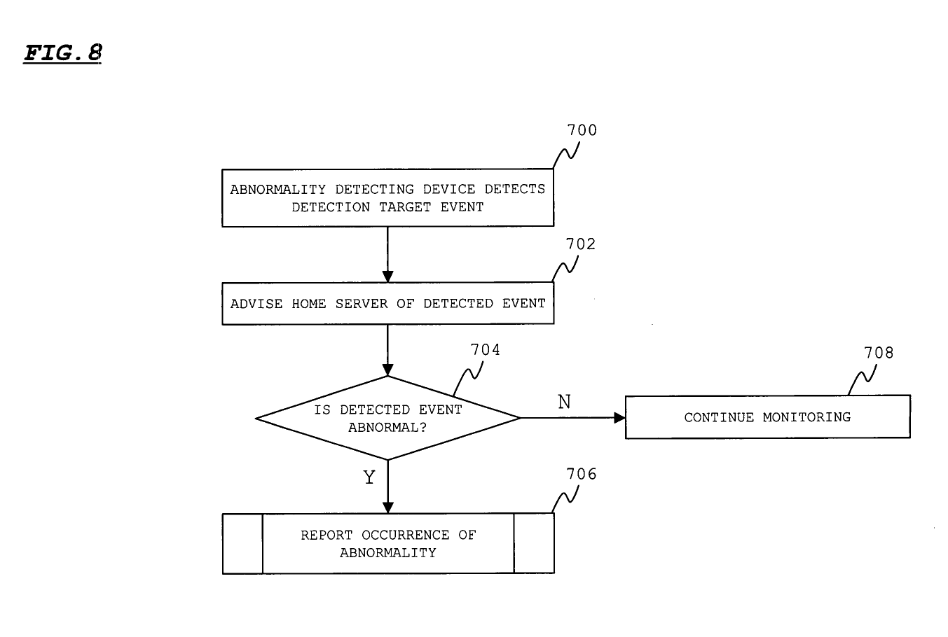

FIG. 8 is a flowchart schematically showing an overall processing of reporting the occurrence of an abnormality.

First of all, when detecting a detection target event (S700) while the system is monitoring the occurrence of an abnormality, the abnormality detecting device 10 sends event occurrence information to the home server 30 (S702).

In the home server 30, when the event occurrence information receiving portion 301 receives the event occurrence information, the abnormality determining portion 303 determines, on the basis of data stored in the abnormality information storing portion 302, whether or not the event detected by the abnormality detecting device 10 indicates an abnormal state, and makes an analysis of the abnormal state (S704).

If the abnormality determining portion 303 determines in step S704 that the abnormal state has arisen (S704: Y), a processing for reporting the occurrence of the abnormality is performed (S706) On the other hand, if the abnormality determining portion 303 determines that no abnormal state has arisen (S704: N), the occurrence of an abnormality is continuously monitored (S708).

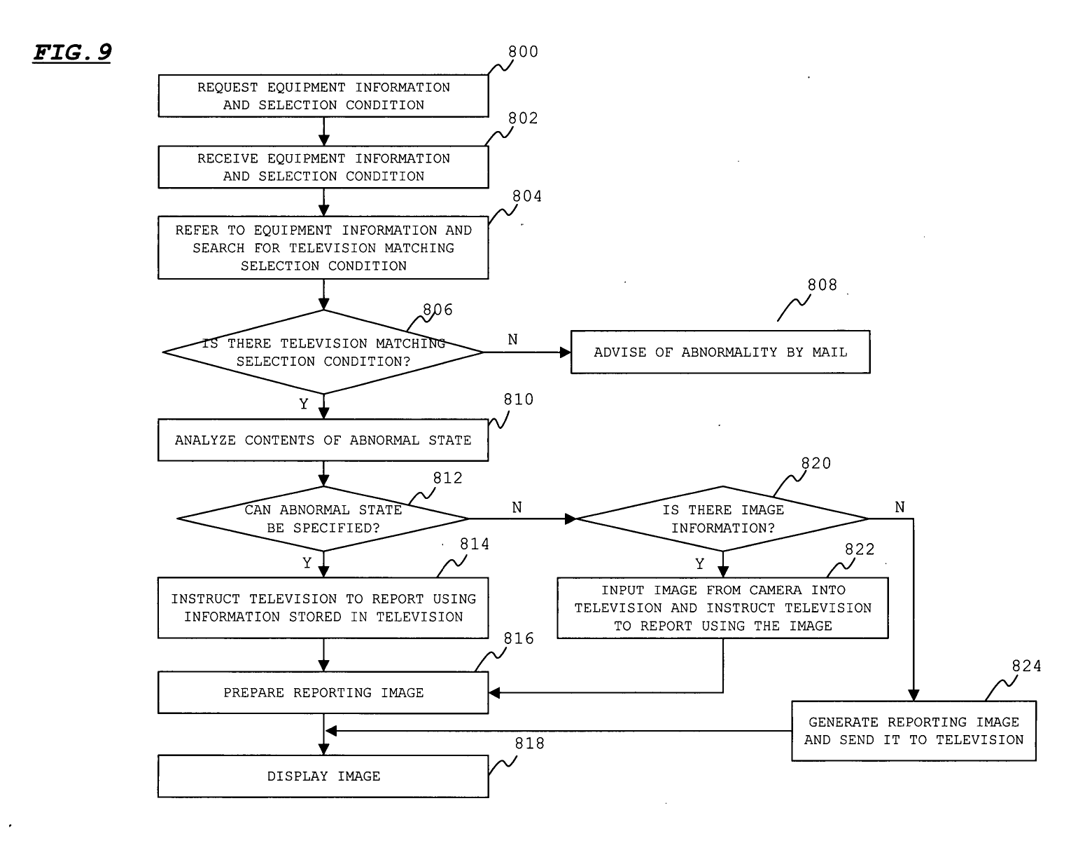

FIG. 9 is a flowchart schematically showing the processing in step S706 of FIG. 8.

This flowchart includes processing steps (S800 to S808) for selecting a television for outputting the occurrence of an abnormality out of a plurality of televisions connected to the network and processing steps (S810 to S824) for causing the selected television to display a screen corresponding to the contents of the abnormality.

First of all, if it is determined in the aforementioned processing in step S704 that the detected event indicates the abnormal state (S704: Y), the abnormality determining portion 303 of the home server 30 sends to the control information sending portion 311 control information for reporting the occurrence of an abnormality, which includes an analysis result of the abnormal state. At the same time, the abnormality determining portion 303 instructs the information requesting portion 313 to acquire from the terminal 20 TV selection condition information, TV display condition information, and TV equipment information on all the televisions connected to the network.

Based on this instruction, the information requesting portion 313 sends to the terminal 20 a request to send the TV selection condition information, the TV display condition information, and the TV equipment information on all the televisions connected to the network (S800).

The request-to-send sent from the information requesting portion 313 of the home server 30 is received by the information request receiving portion 211 of the terminal 20. In the terminal 20, on the basis of the request-to-send received by the information request receiving portion 211, the selection condition sending portion 207 reads the TV selection condition information and the TV display condition information from the selection condition storing portion 206 and sends them to the home server 30, and the equipment information sending portion 205 reads the TV equipment information on all the televisions on the network from the equipment information storing portion 204 and sends it to the home server 30.

The TV selection condition information and the TV display condition information sent by the selection condition sending portion 207 of the terminal 20 and the TV equipment information sent by the equipment information sending portion 205 of the terminal 20 are received by the selection condition receiving portion 309 of the home server 30 and the equipment information receiving portion 308, respectively (S802).

Then, the warning destination determining portion 310 of the home server 30 refers to the TV equipment information received by the equipment information receiving portion 308 and the TV selection condition information received by the selection condition receiving portion 309, and conducts a retrieval for detecting all the televisions matching the TV selection condition information (S804).

In this retrieval, if no television matching the TV selection condition information is detected (S806: N), the mail sending portion 307 of the home server 30 acquires from the mail address storing portion 306 a mail address of a destination to which the occurrence of an abnormality is reported, and sends to the mail address a mail including information indicating the occurrence of the abnormality.

On the other hand, if a television matching the TV selection condition information is detected (S806: Y), the control information sending portion 311 analyzes the contents of the abnormal state on the basis of the control information sent from the abnormality determining portion 303 (S810), and determines, on the basis of an analysis result of the contents of the abnormal state, whether or not a type and a place of occurrence of the occurrent abnormality can be specified (S812).

If it is determined in step S812 that the type and place of occurrence of the abnormality can be specified (S812: Y), the control information sending portion 311 sends to the television 50 control information including pieces of information on the type of the occurrent abnormality, the place of occurrence of the abnormality, and the like, such that images corresponding to the type of the occurrent abnormality and the place of occurrence are outputted from among the standard images stored in advance in the image storing portion 508 of the television 50 (S814).

In this case, in the television 50, when the control information receiving portion 502 receives the control information sent from the control information sending portion 311 of the home server 30, a corresponding piece of image information is acquired from the image storing portion 508 on the basis of the received control information, and a control for displaying the acquired image information in the display portion 509 is performed (S816). Owing to this control, the display portion 509 displays an image (Standard image) for reporting the occurrent abnormality (S818).

On the other hand, if it is determined in step S812 that the type and place of occurrence of the occurrent abnormality cannot be specified (S812: N), the control information sending portion 311 sends to the television 50 control information including pieces of information on the state of the occurrent abnormality, the place of occurrence of the abnormality, and the like. At the same time, it is determined whether or not there is an image picked up by the camera 60 as to the occurrent abnormality (S820).

If it is determined in step S820 that there is an image picked up by the camera 60 as to the occurrent abnormality (S820: Y), the control information sending portion 311 sends control information to the camera 60 so that the camera 60 outputs the picked-up image to the television 50 (S822).

In this case, after the television 50 has received image information from the camera 60, a corresponding piece of image information for reporting the abnormality is read out from the image storing portion 508 on the basis of the control information received by the control information receiving portion 502 from the control information sending portion 311 of the home server 30, and then is outputted to the image synthesizing portion 507. The image synthesizing portion 507 synthesizes this image with the image picked up by the camera 60 and received from the image inputting portion 506, and performs a control to display a resultant synthetic image in the display portion 509 (S816). Based on this control, the display portion 509 displays an image (Standard image+ picked-up image) for reporting the abnormality (S818).

If it is determined in step S820 that there is no image picked up by the camera 60 as to the occurrent abnormality (S820: N), the control information sending portion 311 of the home server 30 instructs the image generating portion 304 to generate an abnormality reporting image. Based on this instruction, the image generating portion 304 generates image information for reporting the abnormality and sends it to the reporting image sending portion 305. The reporting image sending portion 305 receives image information for reporting the abnormality, which is generated by the image generating portion 304, and sends the received image information to the television 50 (S824).

In this case, in the television 50, when the control information receiving portion 502 receives control information sent from the control information sending portion 311 of the home server 30 and the reporting image receiving portion 501 receives the image information for reporting the abnormality, which has been sent from the reporting image sending portion 305 of the home server 30, the control information receiving portion 502 performs a control to display the received reporting image in the display portion 509 on the basis of the received control information. Based on this control, the display portion 509 displays the abnormality reporting image (the image generated by the home server 30) (S818).

The image display in step S818 is carried out according to the TV display condition information set by the user (See FIG. 6B). In this case, the home server 30 determines, on the basis of the TV display condition information and TV equipment information acquired from the terminal 20, whether or not a television caused to output the occurrence of an abnormality is endowed with a split-screen display function. The home server 30 sends control information including information on a condition of a display area to a television endowed with the split-screen display function. The home server 30 sends control information including no information on the condition of the display area to a television unendowed with the split-screen display function.

If the television 50 has the split-screen display function, it sets an area for displaying the occurrence of an abnormality according to a condition received from the home server 30, and outputs an abnormality reporting image to the set area. For instance, when the condition is “that the occurrence of the abnormality is displayed on part of the screen”, the television 50 splits its display screen into areas and displays a currently displayed image and an abnormality occurrence reporting image in the corresponding areas, respectively. If the television 50 is not in the display operation at this moment, it may be so controlled as to display the abnormality occurrence reporting image on the entire screen. On the other hand, if the television 50 is not endowed with the split-screen display function, the abnormality occurrence reporting image is displayed on the entire screen.

(Second Embodiment)

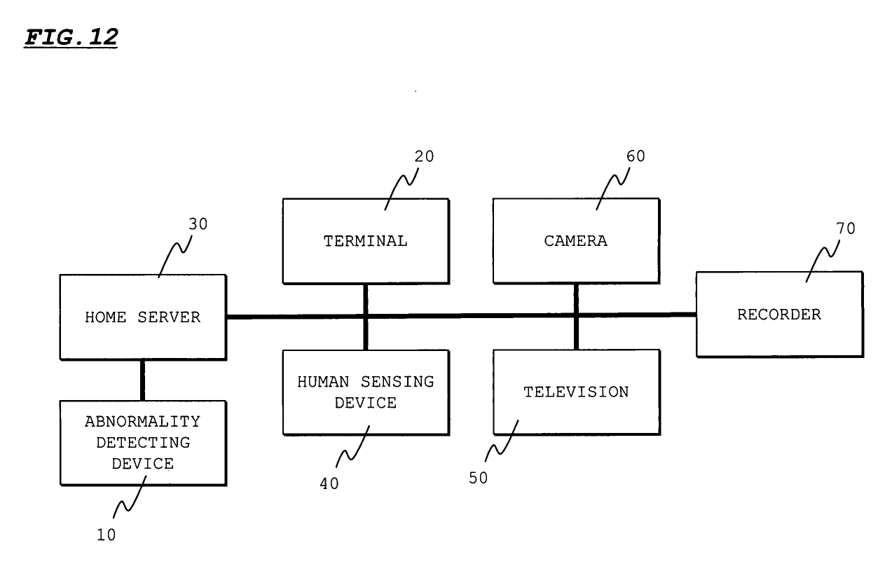

FIG. 12 shows a configuration of a warning system according to a second embodiment of the present invention. A recorder 70 is connected to the warning system of this embodiment via the network. The warning system of the second embodiment is identical in other configurational details with that of the first embodiment shown in FIG. 1.

The recorder 70 can not only record programs viewable on the television 50 but also perform various operations on the basis of control information obtained from the home server 30 and the like. This recorder 70 is further endowed with a function of sending to the terminal 20 information indicating a state thereof, such as an on/off state of a power source and an operating condition thereof. The information sent from the recorder 70 is received by the equipment information receiving portion 208 of the terminal 20, and is stored into the equipment information storing portion 204 as the equipment information on the recorder 70.

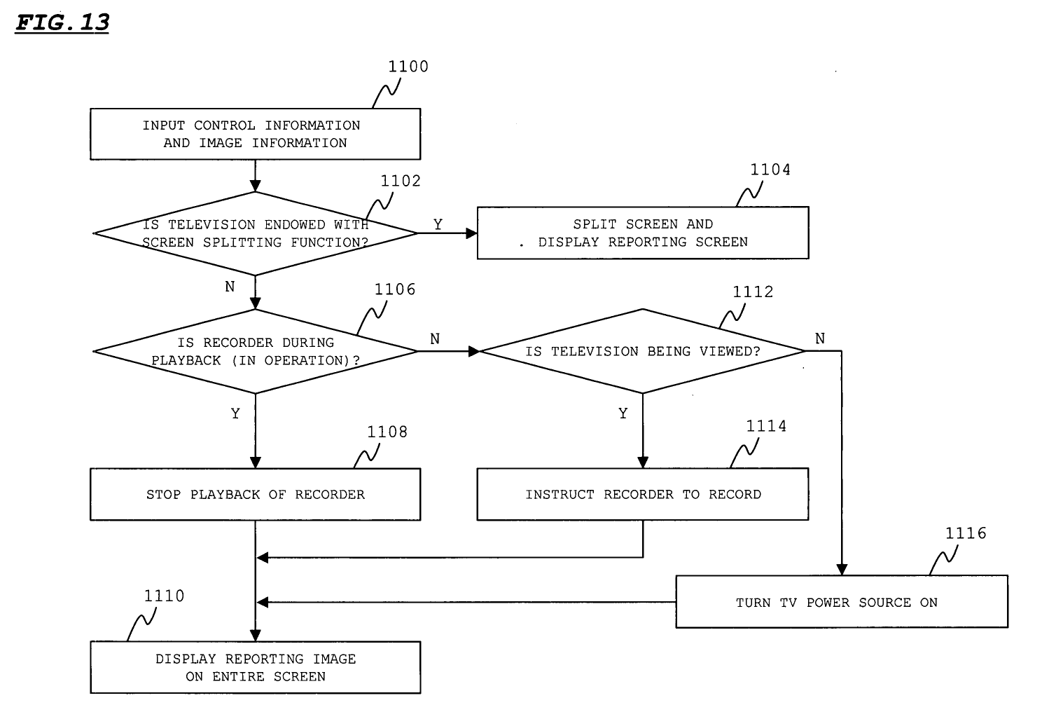

FIG. 13 is a flowchart schematically showing a processing according to step S818 of FIG. 9 in the first embodiment. The processing according to step S818 of FIG. 9 will be described hereinafter.

In the home server 30, the control information sending portion 311 determines, on the basis of equipment information on the television 50 (TV equipment information) received from the equipment information receiving portion 308, whether or not the television 50 for outputting the occurrence of an abnormality is endowed with the split-screen display function (S1102).

Herein, if the television 50 is endowed with the split-screen display function (S1102: Y), the control information sending portion 311 sends to the television 50 control information for performing a control so as to display reporting information on part of the split screen.

In the television 50, on the basis of the control information received by the control information receiving portion 502, a reporting image is displayed on part of the split screen of the display portion 509 (S1104).

On the other hand, if the television 50 is not endowed with the split-screen display function (S1102: N), the control information sending portion 311 of the home server 30 determines, on the basis of the equipment information on the recorder 70 received from the equipment information receiving portion 308, whether or not the recorder 70 is currently during playback (S1106).

If it is determined in step S1106 that the recorder 70 is currently during playback and that its playback output is being outputted to the television 50 (S1106: Y), the control information sending portion 311 sends to the recorder 70 control information for performing a control to stop playback of the recorder 70. The control information sending portion 311 also sends to the television 50 control information for performing a control to display reporting information on the entire screen.

Based on the received control information, the recorder 70 stops its current playback (S1108). Based on the control information received by the control information receiving portion 502, the television 50 performs a control to display an abnormality reporting image on the entire screen of the display portion 509. Based on this control, the display portion 509 displays the abnormality reporting image (S1110).

In step S1106, on the other hand, if the recorder 70 is currently stopped (S1106: N), the control information sending portion 311 determines whether the television 50 displays a received broadcast or its power source is off (S1112).

If it is determined in step S1112 that the television 50 has received and displayed the broadcast (S1112: Y), the control information sending portion 311 of the home server 30 sends to the recorder 70 control information for performing a control to record a broadcast of a currently received channel. At this moment, the control information sent from the home server 30 includes information required for recording by the recorder 70, that is, information indicating the received channel which is acquired from the equipment information on the television 50 (TV equipment information), and information as an instruction for recording which is acquired from separately stored program information or the like and which includes start and finish times of a currently received broadcast program.

The control information sending portion 311 sends to the television 50 control information for performing a control to display reporting information on the entire screen.

The recorder 70 that has received the control information sent from the home server 30 records a television program of a designated channel until its finish time on the basis of the received control information, namely, the information as an instruction for recording (S1114).

On the other hand, the television 50 performs a control to display an abnormality reporting image on the entire screen of the display portion 509 on the basis of the control information received by the control information receiving portion 502. Based on this control, the display portion 509 displays the abnormality reporting image (S1110).

In the aforementioned step S1112, if the power source of the television 50 is off (S1112: N), the control information sending portion 311 of the home server 30 sends to the television 50 control information for performing a control to turn the power source on. Furthermore, the control information sending portion 311 sends to the television 50 control information for performing the control to display reporting information on the entire screen.

The television 50 turns its power source on based on the control information received by the control information receiving portion 502 (S1116), and performs the control to display an abnormality reporting image on the entire screen of the display portion 509 (S1110).

The above-mentioned first and second embodiment makes it possible to reduce the time required for communication and report an abnormality more promptly by making a determination on the abnormality by means of the indoor server at the time of the occurrence of the abnormality.

By setting in advance a condition of a display device for reporting an abnormality and determining the display device for reporting the abnormality on the basis of the condition and the circumstances of indoor displayable devices, a warning can be issued to indoor display devices endowed with a display function, including a television in a room. Thus, it is possible to provide an environment in which a user easily notices the warning when staying indoors.

In addition, since an abnormality reporting image is displayed according to the contents of an abnormality, a warning easily visible by the user can be displayed.

Although the embodiments of the present invention have been described, it goes without saying that the present invention should not be limited to those embodiments and may be subjected to a variety of other modifications.

The embodiments of the present invention may be subjected, as appropriate, to various modifications within the scope of technical ideas expressed by the claims.

1. A server connected to a display device in a home network, the server comprising:
an abnormality occurrence determining portion that determines that an abnormality has occurred; and
a display device determining portion that decides on a display device for reporting an abnormality based on a condition for selecting an abnormality reporting display device and information on display devices in the home network, when the abnormality occurrence determining portion determines that the abnormality has occurred.

2. A server according to claim 1, further comprising a mail sending portion that sends to a predetermined address a mail including information indicating that an abnormality has occurred, when the display device determining portion decides that there is no abnormality reporting display device.

3. A server according to claim 1, further comprising a control information sending portion that sends control information as an instruction for reporting to the display device on which the display device determining portion has decided.

4. A server according to claim 3, wherein:
the abnormality occurrence determining portion comprises an abnormality analyzing portion that analyzes contents of an occurrent abnormality; and
the control information sending portion sends control information as an instruction for reporting to the display device on which the display device determining portion has decided, based on a result of an abnormality analysis conducted by the abnormality analyzing portion.

5. A server according to claim 4, wherein the control information is information that designates a reporting image to be displayed.

6. A server according to claim 4, further comprising:
an image generating portion that generates a reporting image; and
an image sending portion that sends the generated image to the display device on which the display device determining portion has decided,
wherein the control information sending portion controls, based on a result of an abnormality analysis conducted by the abnormality analyzing portion, the image generating portion to generate a reporting image, and controls the image sending portion to send the generated image therefrom.

7. A server according to claim 4, wherein the control information sending portion sends to a camera connected to the home network control information as an instruction to send a picked-up image to the display device on which the display device determining portion has decided, based on a result of an abnormality analysis conducted by the abnormality analyzing portion, and sends to the display device on which the display device determining portion has decided control information as an instruction to display an image received from the camera.

8. A server according to any one of claims 1 to 7, wherein the condition for selecting the abnormality reporting display device includes that a power source of the display device is on.

9. A server according to any one of claims 1 to 7, wherein the condition for selecting the abnormality reporting display device includes that there is someone in proximity to the display device.

10. A server according to any one of claims 1 to 7, wherein the condition for selecting the abnormality reporting display device includes that all the display devices in the home network report the abnormality.

11. A server according to claim 1, wherein the display device is a television and further comprises:
a display device use situation determining portion that determines whether or not the display device on which the display device determining portion has decided is currently displaying a television program; and
a recording instructing portion that provide a recorder connected to the home network with an instruction to record a television program of a channel currently selected by the display device, including information indicating the channel, if the display device use situation determining portion determines that the display device on which the display device determining portion has decided is currently displaying the television program.

12. A display device connected to a server for controlling an equipment in a home network, the display device comprising:
an image storing portion that stores an image used to report an abnormality;
a control information processing portion that receives control information as an instruction to report an abnormality from the server and controls the reporting of the abnormality based on the received control information; and
a display portion that displays the image stored in the image storing portion based on the control performed by the control information processing portion.

13. A display device according to claim 12, wherein the display portion synthesizes information different from the image stored in the image storing portion with the image based on the control performed by the control information processing portion, and displays a resultant synthetic image.

14. A display device according to claim 12 or 13, further comprising a camera image receiving portion that receives an image from a camera in the network,
wherein the display portion synthesizes a camera image received from the camera image receiving portion with the image stored in the image storing portion based on the control performed by the control information processing portion, and displays a resultant synthetic image.
